(19) United States
(12) Patent Application Publication
(10) Pub. No.: US 2008/0076429 A1
(43) Pub. Date: Mar. 27, 2008

(54) SYSTEM FOR CONTROL, MANAGEMENT, AND TRANSMISSION FOR SOFT HANDOFF IN AN OFDMA-BASED COMMUNICATION SYSTEM

(75) Inventors: David Comstock, San Diego, CA (US); Jianmin Lu, San Diego, CA (US); Anthony C.K. Soong, Plano, TX (US); Zhigang Rong, San Diego, CA (US); Jung Woon Lee, Allen, TX (US)

Correspondence Address: AKIN GUMP STRAUSS HAUER & FELD, LLP, P O BOX 688, DALLAS, TX, 75313-0688, US

(73) Assignee: Futurewei Technologies, Inc., Plano, TX (US)

(21) Appl. No.: 11/851,845

(22) Filed: Sep. 7, 2007

Related U.S. Application Data
(60) Provisional application No. 60/824,937, filed on Sep. 8, 2006.

(51) Int. Cl. H04Q 7/20

(52) U.S. Cl. 455/437; 455/442

(57) ABSTRACT

A versatile system for controlling and managing resources for Soft Handoff Group operations is disclosed. The system determines which of a plurality of sectors in an access network is a serving sector for an access terminal. An active set of the plurality of sectors is assigned to the access terminal, comprising the serving sector. A soft handoff set for the access terminal is identified from the active set. A soft handoff group for the access terminal is identified from the soft handoff set. The access terminal's transmissions within the access network are managed according to the identified soft handoff group.

### PRIORITY CLAIM

This application claims the priority benefit of U.S. Provisional Application No. 60/824,937, filed Sep. 8, 2006.

### CROSS-REFERENCE TO RELATED APPLICATIONS

This application is related to: U.S. Application Ser. No. 60/783,507, filed on Mar. 17, 2006 for “Method And Apparatus For Enabling Soft Handoff In An OFDMA-Based Communication System”, by Anthony C. K. Soong, Yunsong Yang, Jianmin Lu, and Jung Woon Lee; U.S. Application Ser. No. 60/823,232, filed on Aug. 22, 2006 for “A Signaling Protocol For Supporting Soft Handoff In An OFDMA-Based Communication System”, by Jianmin Lu, Yunsong Yang, and Anthony C. K. Soong; and U.S. Application Ser. No. 60/839,972, filed on Aug. 24, 2006 for “Method And Apparatus For Enabling The Common Radio Resources For Soft Handoff In An OFDMA-Based Communication System”, by Anthony C. K. Soong, Zhigang Rong, and Jianmin Liu.

### TECHNICAL FIELD OF THE INVENTION

The present invention relates generally to wireless telecommunications, and more particularly, to a versatile system for soft handoff in orthogonal frequency division multiplexing (OFDM) and orthogonal frequency division multiple access (OFDMA) communication systems.

### BACKGROUND OF THE INVENTION

In most conventional cellular communication networks based on OFDMA, a base station communicates with mobile stations that are within its coverage by using signals that are orthogonal in frequency. Conventional “Third-Generation” (3G) systems achieve significant increase in throughput over second-generation (2G) systems by taking advantage of multi-user diversity gain. As such, for point to multipoint systems (e.g., forward link), all resources of a base station are dedicated to a single user at a time. A scheduler selects a single user—having a best radio condition from among a set of users—to send data to. If the set of users is large enough, and channel fading of each user is independent, there is generally a user in good radio condition to serve. Consequently, the base station avoids the expense of sending information to a user having a poor radio condition.

In order to facilitate movement of a mobile station through an area of service (i.e., mobility), a fast sector section technique may be employed. This allows a mobile station to quickly switch transmission of data from one sector to another. Although the mobile station may switch from sector to sector, at any instant in time it only receives signaling from a single sector.

For a user in a boundary or transition area between two or more sectors of a given cell (i.e., cell edge), a signal received by a mobile station is often received with very low power, even though a base station transmits to the mobile station with maximum power. As a result, the mobile station is in very poor radio condition, and thus its data throughput is very low. This may have several detrimental effects on system performance.

First, if a mobile station requires a certain Quality of Service (QoS), the base station must expend significant resources to serve that mobile station. This causes a significant decrease in total system throughput. Second, the perceived user experience for the mobile station is very poor due to the fact that data rate that can be sustained with that link is very low. This is a significant issue because users expect to have a same user experience regardless of where users are located in the sector.

Therefore, there is a need to increase throughput of users at an edge of a sector. More particularly, there is a need to provide soft handoff in an OFDM system that optimizes user performance at sector edges.

### SUMMARY OF THE INVENTION

The present invention provides a system, comprising various methods and apparatus, for soft handoff of mobile stations (MSs) in order to improve performance—particularly for mobile stations at an edge of a sector—with reliable and minimal signaling overhead. A base station may determine which sectors are in a Soft Handoff Set (SHOS), and which SHOGs from within the SHOS a mobile station may use at a given time. A base station may identify available SHOSes and SHOGs when an Active Set for a mobile station is assigned. In a message assigning an Active Set, record fields for sectors in a given SHOS may be slotted consecutively (or serially). Indication of whether a sector is the first of a new SHOS may be provided in a field of the sector's record. The present invention further provides that a base station may identify members of its own SHOS that are available for SHOG operation, to facilitate an MS request for soft handoff operation during a data connection setup.

The present invention provides that an MS may determine SHOSes and SHOGs, and request service from a SHOG. A SHOG may be identified by an MS using a scrambling code on a reverse link control channel in conjunction with a message field. The present invention also provides a scrambling code scheme for identifying a SHOG ID in a forward link.

The present invention also provides that Channel Quality Information (CQI) of a combined channel for a SHOG may be fed back to a base station from an MS in a sector. In certain embodiments, differences between a combined channel CQI and a serving sector CQI may be provided.

According to the system of the present invention, SHOG transmission for 3GPP2 Strictly Backward Compatible (SBC) mode of 1xEV-DO, Rev. C, may be performed on a traffic data channel—particularly in an OFDM format. In such SHOG transmission applications, a macro antenna in the group may serve as a single antenna for a sector. Thus, a group with multiple macro antennas may serve an Access Terminal (AT) in a Multiple-Input Multiple-Output (MIMO) scheme.

The following description and drawings set forth in detail a number of illustrative embodiments of the invention. These embodiments are indicative of but a few of the various ways in which the present invention may be utilized.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram depicting an illustrative determination of a sector's Soft Handoff Groups (SHOGs), and corresponding SHOG IDs based on information received, according to the present invention; and

FIG. 2 depicts an illustrative example of providing SHOG ID of an active SHOG, using a scrambling code on a forward link control channel, in accordance with the present invention.

### DETAILED DESCRIPTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown, but is to be accorded the widest scope consistent with the principles and features disclosed herein.

The present invention provides a system for soft handoff of mobile stations (MSs)—or Access Terminals (ATs)—with reliable and minimal signaling overhead. The system of the present invention is particularly useful for MSs at the edge of a sector. A base station may determine which sectors are in a Soft Handoff Set (SHOS), and which SHOGs from within the SHOS a mobile station may use at a given time.

In order to facilitate the description of the present invention, the following terms are defined:
An MS's Active Set is a set of sectors that may be used for a period of time for its data transmissions.
An MS's serving sector is a member of its Active Set from which it receives air interface resource assignments.
A Soft Handoff (SHO) Transmission is transmission of identical data from more than one base station—where air interface resources relating to transmission time and frequency are the same (i.e., the transmissions are synchronous), the base stations use a same forward link hopping pattern for SHO subcarrier assignments, and the base stations use a same scrambling sequence.
A Soft Handoff Set (SHOS) is a subset of the Active Set whose members meet requirements to be used for SHO transmissions.
A Soft Handoff Group (SHOG) is a subset of a SHOS.

The system of the present invention provides management for SHOSes and SHOGs. With the present invention, a base station may determine and identify SHOSes and SHOGs to an MS. In certain embodiments, a base station may determine which sectors are in a SHOS, and which SHOGs an MS may use at a given time. A base station may identify available SHOSes and SHOGs when an MS's Active Set is assigned. In an Active Set assignment message, record fields for sectors in a SHOS may be slotted consecutively (or serially). Indication of whether a sector is the first of a new SHOS may be provided in a field of the sector's record. Table 1 provides an illustrative example of such a structure:

TABLE 1
Number of sectors = 6

| | |
|---|---|
| Sector 1 | Sector1RCQICHScramblingSeq |
| | SHOSetStart = 1 |
| Sector 2 | Sector2RCQICHScramblingSeq |
| | SHOSetStart= 0 |
| Sector 3 | Sector3RCQICHScramblingSeq |
| | SHOSetStart:= 0 |
| Sector 4 | Sector4RCQICHScramblingSeq |
| | SHOSetStart= 1 |
| Sector 5 | Sector5RCQICHScramblingSeq |
| | SHOSetStart= 0 |
| Sector 6 | Sector6RCQICHScramblingSeq |
| | SHOSetStart= 1 |

Each sector record includes a Scrambling Sequence field, utilized in identifying the sector, and a field to indicate whether the sector starts a new SHOS (SHOSetStart).

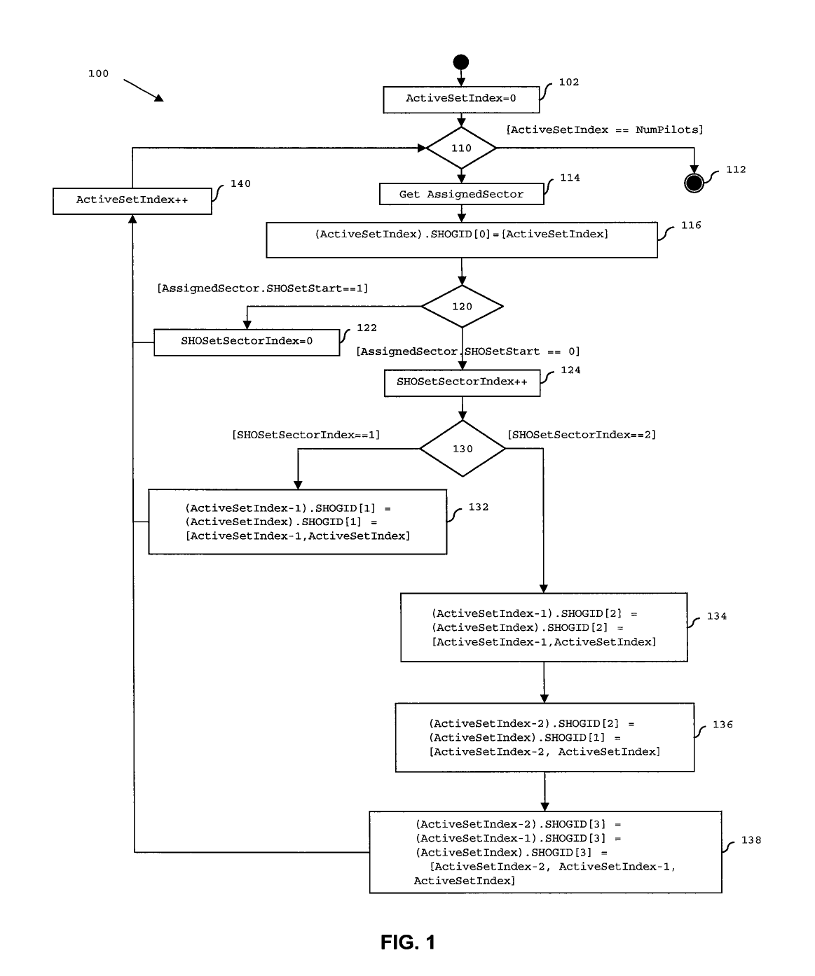

Referring now to FIG. 1, flow charted procedure 100 illustratively depicts a process for an MS to utilize the SHOSetStart field to determine SHOG ID mapping. An MS may utilize such a procedure to determine a sector's SHOGs, and corresponding SHOG IDs. At an initial state, an MS receives a message having sectors in the Active Set ordered by SHOSes. A field may be associated with each sector to provide indication of the start of a new SHOS, as illustrated in Table 1.

A number of values and variables are depicted in procedure 100. ActiveSetIndex is an index for sectors in an Active Set. ActiveSetIndex is initialized to “0” and incremented when a new Sector (AssignedSector) is retrieved from a message. It is used to identify sectors in an Active Set, such as when SHOG IDs are mapped to sectors. Its record may have an array SHOGID [0 . . . 3], where each array element contains a list of sectors associated with a corresponding SHOG ID for a given sector. AssignedSector is a sector record most recently retrieved from a received Active Set assignment message. It may have a SHOSetStart field, indicating whether the sector is a start of a new SHOS. SHOSetSectorIndex is an index for sectors in a single SHOS. This index is initialized to 0 at the start of a new SHOS, and incremented when a new Sector (AssignedSector) is retrieved that is not the start of a new SHOS. NumPilots indicates the number of sectors included in an Active Set.

Procedure 100 also involves a sequence of actions or activities. ActiveSetIndex is initialized to 0 at the start of the procedure, in step 102. At step 110, a check is made as to whether or not all sectors are retrieved. If all sectors of an Active Set are retrieved from a message, the procedure ends 112. If not all sectors are retrieved, another sector is retrieved 114 from the message. For all sectors, SHOGID of “00” is the SHOG with only a given sector as a member. Current sector SHOGID[0] is set 116 to its default.

A determination 120 is made as to whether the current sector is start of a new SHOS or not. If the current sector starts a new SHOS, then: SHOSetSectorIndex is set 122 to 0; ActiveSetIndex is incremented 140; and a next sector is retrieved 110. If the current sector does not start a new SHOS, then SHOSetSectorIndex is incremented 124.

At 130, SHOG ID is determined according to number of sectors in the current SHOS. If SHOSetSectorIndex is 1, then the current SHOS contains at least 2 sectors: the current sector and a previous sector. Each SHOGID[1] associated with the 1st and 2nd sectors in the SHOS forms 132 a set associating both sectors. Operation returns to increment 140 ActiveSetIndex, and retrieve 110 a next sector.

A SHOSetSectorIndex of 2 indicates that the current SHOS contains 3 sectors: the current sector; and a previous 2 sectors. Each SHOGID[2] associated with the previous sectors in the SHOS forms 134 a set associating both sectors. The SHOGID[2] of the 1st sector and the SHOGID[1] of the 3rd sector form 136 a set associating 1st and 3rd sectors. SHOGID[3] of all 3 sectors form 138 a set associating all sectors in the SHOS. Operation returns to increment 140 ActiveSetIndex, and retrieve 110 a next sector.

Table 2 provides an illustration of resulting SHOGs for each sector, and corresponding SHOG IDs, for the example illustrated in Table 1:

TABLE 2
Sector 1
Sector 1 R-CQICH scrambling sequence

| SHOG ID | SHOG |
|---|---|
| 0 | Sector 1 |
| 1 | Sector 1 + 2 |
| 2 | Sector 1 + 3 |
| 3 | Sector 1 + 2 + 3 |

| | |
|---|---|
| SHOG | SHOG ID |

Sector 2
Sector 2 R-CQICH scrambling sequence

| | |
|---|---|
| Sector 2 | 0 |
| Sector 1 + 2 | 1 |
| Sector 2 + 3 | 2 |
| Sector 1 + 2 + 3 | 3 |
| Sector 3 | |

Sector 3 R-CQICH scrambling sequence

| | |
|---|---|
| Sector 3 | 0 |
| Sector 1 + 3 | 1 |
| Sector 2 + 3 | 2 |
| Sector 1 + 2 + 3 | 3 |
| Sector 4 | |

Sector 4 R-CQICH scrambling sequence

| | |
|---|---|
| Sector 4 | 0 |
| Sector 4 + 5 | 1 |
| Sector 5 | |

Sector 5 R-CQICH scrambling sequence

| | |
|---|---|
| Sector 5 | 0 |
| Sector 4 + 5 | 1 |
| Sector 6 | |

Sector 6 R-CQICH scrambling sequence

| | |
|---|---|
| Sector 6 | 0 |

The first sector has a message field set to ‘1’ to indicate that it starts a new SHOS. The next 2 sectors are part of the same SHOS, so their corresponding fields are set to ‘0’ for each. Sectors 4 and 5 are in a new SHOS, so the corresponding field of sector 4 is set to ‘1’, and ‘0’ for sector 5. Sector 6 is in a SHOG comprising 1 sector, so its corresponding field is set to ‘1’. If another sector (Sector 7, not shown) were included in the Active Set, its corresponding field would be set to ‘1’, since sector 6 is a single-sector SHOG.

In the embodiment illustrated, for any message and at any particular time, SHOSes are limited to 3 sectors. If more than 3 sectors are necessary or desired for a SHOS (e.g., a six sector cell), the three sector limitation for a SHOS may be changed by sending a new message. Thus, although Soft Handoff Groups are limited to 3 sectors in the illustrated embodiment, the present invention does not impose such a restriction. Other structure, arrangement, and methods may be utilized toward the same ends—such as, for example, using a bitmap to indicate which sectors form a SHOS.

Also, in the illustrated embodiment, a base station may identify—for MSs without a data connection—members of its own SHOS that are available for SHOG operation; in order to facilitate an MS requesting SHO as data connection is initially set up. This may accomplished utilizing, for example, a broadcast sector message. The base station may also identify a serving sector channel quality threshold at which a MS may request soft handoff operation. The base station may also identify a threshold for maximum combined channel quality for a SHOG. The base station may include these parameters when an Active Set is assigned.

In accordance with the present invention, an MS may also determine SHOSes and SHOGs, and request SHO service. In certain embodiments, an MS may request SHO operation using a reverse link channel message—such as a Reverse Channel Quality Index Channel (R-CQICH). Table 3 illustratively depicts message structure that may be utilized to request SHOG operation.

TABLE 3
R-CQICH scrambling sequence

| Field | # bits |
|---|---|
| FL Channel Quality | 4 |
| Handoff request | 1 |
| SHOG ID | 2 |
| SHOG combined CQI diff | 2 |

In Table 3, a SHOG identifier (SHOG ID) may indicate the requested SHOG that is associated with a sector, which is identified by an R-CQICH scrambling sequence.

In this embodiment, an R-CQICH channel is scrambled with an R-CQICH scrambling sequence, identifying a sector. The SHOG ID may be determined from information received in an Active Set assignment message. If service is requested from only one sector (i.e., serving sector), the SHOG ID field is set to “00”, and the requested SHOG comprises only the sector identified by the R-CQICH scrambling sequence.

To request a SHOG including the serving sector and one of two other sectors in a three-sector SHOS, SHOG ID is set to: “01” to request inclusion of the sector in the Active Set assignment message that comes before the other sectors in the SHOS; and “10” to request inclusion of the other sector. SHOG ID is set to “11” to request a SHOG including all three sectors of a three-sector SHOS.

In other embodiments, a base station may provide an R-CQICH scrambling sequence for each SHOG, which an MS uses to request SHOG operation. In such embodiments, a SHOG ID is included in an R-CQICH message to identify a SHOG sector associated with Forward Link Channel Quality report and—during a handoff—a handoff target.

In other embodiments, an MS may request that a sector of a SHOG be added, by indicating the sector in a reverse link control channel, and setting a one bit SHO field. In such embodiments, no additional overhead may be required to specify the SHOG in the request. A serving sector may decode the R-CQICH message directly, and add the indicated SHOG sector; or the indicated sector may decode the R-CQICH and send a message over the backhaul to the serving sector that requests the sector be added to the SHO transmission. An MS may request that a sector of a SHOG be removed by indicating the sector in a reverse link control channel, and setting a one bit SHO field. Since the sector is already in the SHOG, this bit setting indicates removal of the sector. In the case of handoff when a SHOG is active, a handoff flag is set to ‘1’. A SHO bit may be utilized to indicate whether or not the MS wants to keep the current SHOG, or to operate with the target sector only.

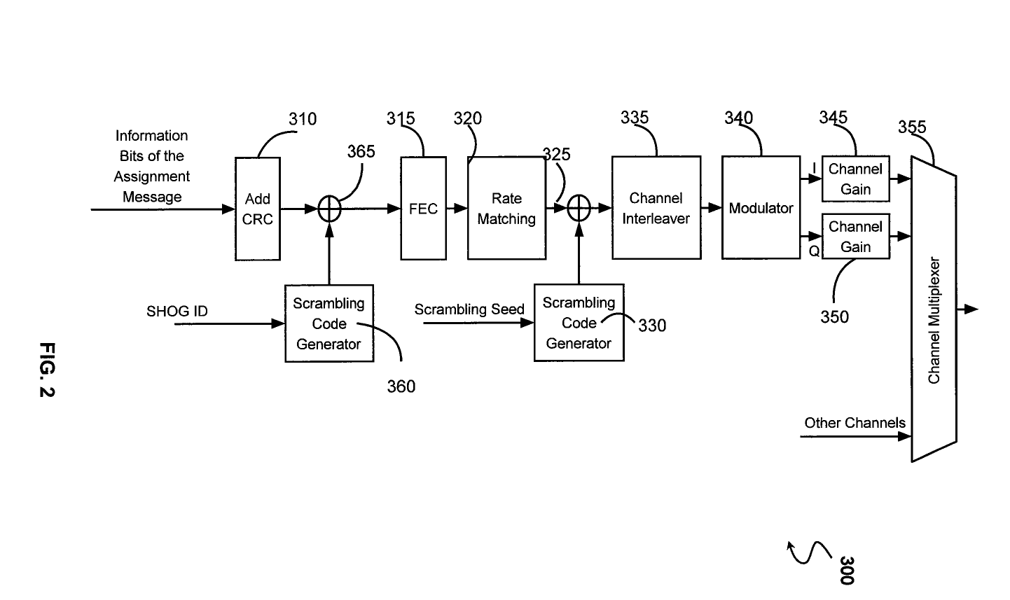

A base station may indicate a SHOG that is active—particularly when common pilot is used for channel estimation—such that an AT/MS is made aware of which sectors should be used in estimating a channel for combined data. In certain embodiments, a base station may provide a SHOG ID to identify a SHOG when making a transmission resource assignment. A scrambling code may be used to identify the SHOG ID in the forward link. This is illustrated in reference to FIG. 2, where a channel structuring 300 is depicted. A scrambling code generation function 360 is provided to apply a scrambling code to the message data, after CRC 310 is added. Interpretation of SHOG ID in such embodiments may be the same as that for embodiments in which an MS so requests.

In other embodiments, SHOG ID information may be provided as a field in a message for assigning transmission resources, as previously illustrated in relation to an MS request. In other embodiments, SHOG ID scrambling may be combined with a scrambling code generation function 330.

The present invention further provides that an MS may feed Channel Quality Information (CQI) of a combined channel—for a SHOG—back to a base station. In certain embodiments, the MS sends the CQI for one sector, and also sends the difference between this CQI and CQI for the combined channel.

While Table 3 illustratively depicts message structure that may comprise these fields, Table 4 illustratively depicts encoding structure for a field representing CQI difference.

TABLE 4

| | Difference between CQI for combined | | |
|---|---|---|---|
| | sectors and FL Channel Quality | | SHOG |
| | 2 sectors | 3 sectors | combined CQI diff |
| 1 sector | 0 | 0 | 00 |
| | 1 | 2 | 01 |
| | 2 | 3 | 10 |
| | 3 | 5 | 11 |

In other embodiments, individual CQI reports for sectors of a SHOG may be sent to a base station, either simultaneously or at different times. The base station may use these CQI reports to estimate CQI for a combined channel.

In further accordance with the present invention: a SHOG may be changed while maintaining a same serving sector; a serving sector may be changed while maintaining a same SHOG; and both a SHOG and a serving sector may be changed. In certain embodiments, the message structure depicted in Table 3 may be utilized to effect such changes.

In order to change serving sector but maintain SHOG, an R-CQICH scrambling sequence may be changed to one associated with a target sector. Forward Link (FL) Channel Quality for the target sector may be included. A SHOG ID may be set to a value associated with a target sector corresponding to a current serving to a current serving SHOG, and a handoff request bit may be set to ‘1’. To change SHOG, a SHOG ID may also be set to a desired SHOG.

A base station with more than one transmitting antenna may also comprise a SHOG. In such instances, a set of antennas from group members may comprise a macro antenna for group transmission. For example, consider that sector A has two antennas, A1 and A2; and sector B has two antennas, B1 and B2. Consider a group, G, comprising sectors A and B. The same waveform (or some type of diversification may be utilized) is transmitted through antennas A1 and B1. Due to soft combining aspects of OFDM, the two transmissions may appear to an MS as a single, non-distinguishable Macro Antenna. Accordingly, antennas A1 and B1 may comprise a Macro Antenna G1. Similarly, antennas A2 and B2 may comprise a Macro Antenna G2. Thus, an MS may recognize that group G is the same as a sector with 2 antennas, G1 and G2. As an alternative, group G may silence one set of Macro Antennas (e.g., G2). In such cases, only one Macro antenna may serve the MS.

In Strictly Backward Compatible (SBC) mode of 3G framework, handoff operation may remain the same as in 1xEV-DO. Thus, an AT/MS may only monitor a control channel sent by its serving sector. Based upon a CDM pilot, the AT/MS makes a handoff request to change serving sector by DRC cover. Handoff operation may be independent from SHOG operation.

In addition to conventional handoff operation, a SHOG transmission on a traffic data channel—especially in OFDM—may be provided. In a SHOG transmission, a macro antenna in a group may serve as a single antenna in a sector. Thus, a group with multiple macro antennas may serve an AT/MS in a MIMO scheme. SHOG set information—such as which sector(s) may comprise a group, and the Group ID, etc. —is communicated to the AT/MS. The SHOG set information may either be broadcast in a common control channel, or unicast in a traffic channel. One example for using broadcast comprises placing information in a neighboring sector list, so that every AT/MS may be aware of current SHOG set information. One example for using unicast comprises an Access Node (AN) and an AT/MS negotiating after a call setup, in upper layer signaling.

Feedback for conventional 1xEV-DO handoff may remain unchanged. Feedback for MIMO in a group may be provided via a macro antenna (for a group transmission) equaling an antenna in a sector. The AT/MS may consider a group with multiple macro antennas as a virtual sector, supporting MIMO. A MIMO operation in such a group may be the same as in a single sector. Feedback for SHOG selection may be based on measurement—an AT/MS may request SHOG service from an AN.

In order to feedback a preferred group and preferred serving sector, a data rate is necessary. A new physical channel may be defined to carry such information. Also, an original 1xEV-DO feedback channel may be re-used. For example, an AN and an AT/MS may negotiate an additional DRC channel, as if the DRC is for a virtual forward link carrier in asymmetric mode of 1xEV-DO rev B. This channel may be named Group Rate Control (GRC) channel—with GRC_Cover (e.g., 3 bits) indicating preferred Group ID; and the GRC content (e.g., 4 bits) carrying data rate control information for that group.

In certain embodiments of SHOG operation, an AT/MS may measure an individual sector channel quality from a Common Spatial Pilot, and calculate a combined channel quality for a potential group. Once a certain criteria is met, an AT/MS may report to an AN by switching cover of GRC to a desired one. Once the AN becomes aware of the switching, the AN may serve the AT/MS through the requested SHOG.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of establishing soft handoff operation for an access terminal operating within an access network, comprising a plurality of sectors, the method comprising the steps of:
determining which of the plurality of sectors is a serving sector for the access terminal;
assigning an active set of the a plurality of sectors, comprising the serving sector, to the access terminal;
identifying a soft handoff set for the access terminal from the active set;
identifying a soft handoff group for the access terminal from the soft handoff set; and
managing the access terminal's transmissions within the access network according to the identified soft handoff group.

2. The method of claim 1, further comprising the step of providing messaging structure having fields adapted to facilitate soft handoff operation for the access terminal.

3. The method of claim 2, wherein the step of providing messaging structure further comprises providing messaging structure comprising a sector-specific scrambling code.

4. The method of claim 2, wherein the step of providing messaging structure further comprises providing messaging structure indicating initiation of a new soft handoff set.

5. The method of claim 2, wherein the step of providing messaging structure further comprises providing messaging structure comprising a soft handoff group identifier.

6. The method of claim 1, wherein the step of identifying a soft handoff group for the access terminal further comprises identifying a soft handoff group comprising only the serving sector.

7. The method of claim 1, wherein the step of identifying a soft handoff group for the access terminal further comprises identifying a soft handoff group comprising the serving sector and any number of other sectors in the active set.

8. A device adapted to facilitate soft handoff operation for an access terminal operating within an access network, comprising a plurality of sectors, the device comprising:
structure adapted to determine which of the plurality of sectors is a serving sector for the access terminal;
structure adapted to assign an active set of the a plurality of sectors, comprising the serving sector, to the access terminal;
structure adapted to identify a soft handoff set for the access terminal from the active set;
structure adapted to identify a soft handoff group for the access terminal from the soft handoff set; and
structure adapted to manage the access terminal's transmissions within the access network according to the identified soft handoff group.

9. The device of claim 8, further comprising messaging structure having fields adapted to facilitate soft handoff operation for the access terminal.

10. The device of claim 9, wherein the messaging structure further comprises a sector-specific scrambling code.

11. The device of claim 9, wherein the messaging structure further comprises an indicator for initiation of a new soft handoff set.

12. The device of claim 9, wherein the messaging structure further comprises a soft handoff group identifier.

13. The device of claim 8, wherein the structure adapted to identify a soft handoff group for the access terminal identifies a soft handoff group comprising only the serving sector.

14. The device of claim 8, wherein the structure adapted to identify a soft handoff group for the access terminal identifies a soft handoff group comprising the serving sector and any number of other sectors in the active set.

15. A method for soft handoff collaboration between a base station and a mobile station in a wireless communications system, the method comprising the steps of:
providing protocol messaging structures adapted to facilitate soft handoff transmissions;
providing a scrambling sequence, associated with a specific sector, from the base station to the mobile station on the forward link;
utilizing the scrambling sequence and protocol messaging structures to format, at the mobile station, a request for soft handoff transmission from the specific sector; and
transmitting, via a reverse link control channel, the request for soft handoff transmission from the mobile station to the base station.

16. The method of claim 15, wherein the step of providing a scrambling sequence further comprises the base station generating an active set assignment message, in which each sector of an active set has, respectively, a unique scrambling sequence field.

17. The method of claim 16, wherein the active set assignment message comprises contiguously arranged fields associated with each sector in a set.

18. The method of claim 16, wherein the active set assignment message comprises a field in a sector record that indicates whether or not that sector is a first sector of a new SHOS.

19. The method of claim 15 further comprising providing a base station broadcast message, identifying members of its own Soft Handoff Set that are available for Soft Handoff Group operation, to mobile stations requesting soft handoff operation when a data connection is initially established.

20. A method for facilitating Soft Handoff Group operation in a system utilizing 3GPP2 Strictly Backward Compatible mode of 1xEV-DO Rev. C, particularly OFDM, the method comprising the steps of:
an access network providing an access terminal with information associated with a Soft Handoff Group set;
enabling the access terminal to operate utilizing a Soft Handoff Group set with multiple macro antennas as a sector that supports multiple input multiple output operation;
utilizing measurement and calculation of Soft Handoff Group set composite channel quality, as determined by the access terminal, to render a Soft Handoff Group switch decision;
transmitting a Soft Handoff Group request from the access terminal through a group rate control channel, which may be a DRC channel.
